(19) United States
(12) Patent Application Publication
(10) Pub. No.: US 2026/0205906 A1
(43) Pub. Date: Jul. 16, 2026

(54) SYSTEM AND METHOD FOR SENSING NODE OR SENSING MODE SWITCHING IN AN INTEGRATED SENSING AND COMMUNICATION SYSTEM

(71) Applicant: Samsung Electronics Co., Ltd., Gyeonggi-do (KR)

(72) Inventors: Liang HU, San Diego, CA (US); Philippe Jean Marc Michel SARTORI, Naperville, IL (US)

(21) Appl. No.: 19/435,163

(22) Filed: Dec. 29, 2025

Related U.S. Application Data
(60) Provisional application No. 63/744,016, filed on Jan. 10, 2025.

(51) Int. Cl. H04W 36/08

(52) U.S. Cl. CPC H04W 36/08

(57) ABSTRACT

A system and a method are disclosed for sensing node or mode switching in an integrated sensing and communication (ISAC) system, the method comprising identifying, by a first node, a second node to perform a sensing operation based on a position or velocity of a mobile object; and transmitting, from the first node, a switch request to the second node, wherein the switch request comprises the position or velocity of the mobile object.

### CROSS-REFERENCE TO RELATED APPLICATION

This application claims the priority benefit under 35 U.S.C. § 119(e) of U.S. Provisional Application No. 63/744,016, filed on January 10, 2025, the disclosure of which is incorporated by reference in its entirety as if fully set forth herein.

### TECHNICAL FIELD

The disclosure generally relates to wireless communication systems. More particularly, the subject matter disclosed herein relates to improvements in sensing operations in integrated sensing and communication (ISAC) systems.

### SUMMARY

ISAC systems may combine sensing and communication functions using the same frequency band and hardware infrastructure. In ISAC systems, sensing signals can be transmitted and received to detect objects that are not actively connected to the wireless network, enabling use cases such as unmanned aerial vehicle (UAV) trajectory tracking, traffic monitoring, and environmental sensing. As wireless technologies evolve with more antenna elements and wider bandwidth in higher frequency bands, such as millimeter wave (mm-wave) bands, sensing capabilities can provide assistance information including distance, angle, instantaneous velocity, and characteristics of objects.

However, maintaining continuous sensing operations may face challenges when objects move across multiple cells. Cell sizes for cellular deployment are relatively small, typically in the order of one kilometer. Mobile objects such as UAVs can move at fast speeds and frequently cross cell boundaries. Without proper mobility management, sensing operations may be interrupted each time a mobile object moves from one cell to another, resulting in gaps in sensing coverage and degraded sensing quality of service (QoS).

One issue with existing approaches is the lack of signaling procedures to enable seamless handover of sensing operations as mobile objects traverse multiple cells. In mono-static sensing, where a single node transmits and receives reflected sensing signals, there may be no established mechanism to transfer sensing responsibilities from one node to another as signal strength degrades. In bi-static sensing, where one node transmits and a different node receives, coordinating the handover of either the transmitter or receiver may require the development of signaling procedures. The absence of such procedures can lead to interrupted sensing coverage, reduced sensing accuracy, and inability to maintain continuous tracking of mobile objects.

Another issue may be the inability to dynamically switch between different sensing modes based on propagation conditions and sensing QoS requirements. When line-of-sight (LOS) conditions exist between a sensing transmitter and a mobile target, mono-static sensing may be sufficient to meet sensing QoS targets while minimizing network resource usage. However, when non-line-of-sight (NLOS) conditions occur, bi-static or multi-static sensing may be needed to achieve the required sensing performance. Without mechanisms to switch between sensing modes, the system cannot flexibly optimize network resource efficiency while maintaining sensing QoS.

To overcome these issues, systems and methods are described herein for sensing node switching and sensing mode switching in ISAC systems. A sensing node may include a base station (BS) or a user equipment (UE) that performs sensing operations by transmitting sensing signals, receiving reflected sensing signals, or both. Sensing node switching may transfer sensing responsibilities from one node to another as a mobile object moves, maintaining continuous sensing coverage with minimum interruption.

The above approaches improve on previous methods because sensing continuity can be maintained as mobile objects move across multiple cells. Sensing node switching procedures may provide seamless transfer of sensing responsibilities with minimum interruption.

According to an embodiment, a method for sensing node or mode switching in an ISAC system is disclosed. The method includes identifying, by a first node, a second node to perform a sensing operation based on a position or velocity of a mobile object; and transmitting, from the first node, a switch request to the second node, wherein the switch request comprises the position or velocity of the mobile object.

According to another embodiment, a system including a first node for sensing node or mode switching in an ISAC system is disclosed. The first node includes a processor; and a memory storing program instructions that, when executed by the processor, configure the first node to identify a second node to perform a sensing operation based on a position or velocity of a mobile object; and transmit a switch request to the second node, wherein the switch request comprises the position or velocity of the mobile object.

### BRIEF DESCRIPTION OF THE DRAWING

In the following section, the aspects of the subject matter disclosed herein will be described with reference to exemplary embodiments illustrated in the figures, in which:

FIG. 1 may illustrate a wireless communication system including UAV flight trajectory tracking, according to embodiments of this disclosure;

FIG. 2 may illustrate various sensing mode configurations, according to embodiments of this disclosure;

FIG. 3 may illustrate a mono-static sensing node switching scheme in a wireless communication system, according to embodiments of this disclosure;

FIG. 4 may illustrate a communication flow diagram for mono-static sensing node switching between a base station and a UE, according to embodiments of this disclosure;

FIG. 5 may illustrate a communication flow diagram for mono-static sensing node switching between a UE and a BS, according to embodiments of this disclosure;

FIG. 6 may illustrate a communication flow diagram for mono-static sensing node switching between BSs, according to embodiments of this disclosure;

FIG. 7 may illustrate a bi-static sensing receiver node switching scheme in a wireless communication system, according to embodiments of this disclosure;

FIG. 8 may illustrate a communication flow diagram for bi-static sensing receiver node switching, according to embodiments of this disclosure;

FIG. 9 may illustrate a bi-static sensing transmitter and receiver node switching scheme in a wireless communication system, according to embodiments of this disclosure;

FIG. 10 may illustrate a communication flow diagram for bi-static sensing transmitter and receiver node switching, according to embodiments of this disclosure;

FIG. 11 may illustrate a communication flow diagram for sensing mode switching from mono-static to bi-static sensing, according to embodiments of this disclosure;

FIG. 12 may illustrate a communication flow diagram for sensing mode switching from bi-static to multi-static sensing, according to embodiments of this disclosure;

FIG. 13 is a flowchart illustrating a method for sensing node or sensing mode switching in an ISAC system, according to embodiments of this disclosure;

FIG. 14 is a block diagram of an electronic device in a network environment, according to embodiments of this disclosure; and

FIG. 15 shows a system including a UE and a gNB, in communication with each other, according to embodiments of this disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts or modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

“Node” as used herein may refer to a network element or device in an ISAC system capable of performing sensing operations, communication operations, or both. A node can include a BS, such as a next-generation NodeB (gNB), or a UE. A first node may perform sensing operations and may initiate a handover switch request when a sensing quality metric degrades below a threshold. A second node may receive the handover switch request and may take over sensing operations from the first node. A node can transmit sensing signals, receive reflected sensing signals from a mobile object, or both, depending on the sensing mode.

“Sensing quality metric” as used herein may refer to a measurement or indicator that characterizes the performance or quality of sensing operations. Examples of sensing quality metrics can include reference signal received power (RSRP) (also referred to as a “sensing RSRP”), reference signal received quality (RSRQ) (also referred to as a “sensing RSRQ”), sensing latency, location accuracy, velocity accuracy, or ratio of correct detection to missed and false detection. When a sensing quality metric falls below a threshold, this can indicate that the current sensing configuration may not provide adequate performance, thereby triggering a handover switch request.

“Sensing operation” as used herein may refer to a type of sensing function or configuration performed by one or more nodes in an ISAC system. A sensing operation can include mono-static sensing node switching, bi-static sensing node switching, multi-static sensing node switching, mode switching between mono-static sensing and bi-static sensing, or mode switching between bi-static sensing and multi-static sensing. In mono-static sensing node switching, a single node may both transmit and receive sensing signals. In bi-static sensing node switching, one node may transmit sensing signals while a different node may receive reflected sensing signals. In multi-static sensing node switching, multiple nodes may be involved in transmitting or receiving sensing signals, or both.

“Mobile object” (or “object”) as used herein may refer to an object that moves through a coverage area of a wireless network and can be tracked or detected using sensing operations. A mobile object can include a UAV, a drone, a vehicle (such as a car or truck), an aircraft, or other moving entity. A mobile object may have associated parameters including position, velocity, Doppler frequency, and micro-Doppler signature. The parameters of a mobile object can be used to identify candidate nodes and can be included in handover switch requests to enable efficient beam tracking.

“Switch request” as used herein may refer to a signaling message transmitted from a first node to a second node to initiate a sensing node switching operation or a sensing mode switching operation in an ISAC system. A switch request can include parameters such as a mobile object’s position and velocity, object identifier, Doppler frequency, micro-Doppler signature, sensing mode, or sensing signal configuration. Depending on context, the switch request may be used to transfer sensing responsibilities between nodes (e.g., in a handover or node switch) or to change the sensing configuration from one mode to another (e.g., from mono-static to bi-static or from bi-static to multi-static).

Wide bandwidths and large antenna arrays, which may be characteristics of high-resolution radar systems, may also be features of modern communication systems. Successive generations of communication systems may have progressed to higher frequency bands, and many key radar bands for high-resolution sensing may overlap with communication bands. For example, radar bands such as K-band (18 gigahertz (GHz) to 26.5 GHz) and Ka-band (26.5 GHz to 40 GHz) may be proximate to mm-wave communication bands. The bandwidth of modern communication systems can be large, thereby enabling opportunities for integrated communication and sensing.

Radar technology and wireless telecommunications may have coexisted for decades, with efforts focused on interference management to allow the two technologies to operate without disturbing one another. However, this approach can result in additional costs for infrastructure and inefficiencies in spectrum usage. ISAC may aim to share spectrum more efficiently and reuse existing wireless network infrastructure for sensing. ISAC may refer to the introduction of sensing capability as part of wireless communication networks. Sensing can refer to radar-like functionality, such as the ability to detect the presence, movement, and other characteristics of objects under the coverage of the wireless network. Sensing can also refer to other types of sensing, such as detection of environmental characteristics or local weather conditions.

The benefit of ISAC, compared to deployment of a separate network to provide sensing functionality, may be that sensing capability can be introduced on a large scale at a relatively low incremental cost by using infrastructure that may be deployed for communication purposes. Massive communication infrastructure may exist, and denser deployment may be available in future generations of wireless communication, which can enable enhanced sensing capabilities. This density can enable not only mono-static sensing, where transmission of the radar signal and reception of the reflected signal may be handled by the same node, but also various bi-static or multi-static sensing where transmission and reception can be handled by different collaborating nodes. Integration of sensing into communication networks can provide better spectrum utilization compared to assigning separate spectrum portions for the different sensing modes.

For mono-static sensing node switching, a source node can monitor sensing signal quality, such as RSRP of reflected sensing signals. When the sensing signal quality falls below a threshold, the source node can identify a candidate target node based on the mobile object’s position and velocity. The source node can transmit a mono-static sensing handover request message to the target node, where the request message includes parameters such as object identifier (ID), position, velocity, and Doppler frequency. The target node can determine a sensing beam direction based on the object position, perform mono-static sensing measurements, and transmit an acknowledgement (ACK) or negative acknowledgement (NACK) to the source node.

For bi-static sensing receiver switching, a BS can transmit sensing signals while a receiving node detects reflected signals from the mobile object. When the receiver’s sensing signal quality degrades, the BS can identify a candidate receiver node and transmit a bi-static sensing receiver request message. The request message can include object position, velocity, Doppler frequency profile, and sensing signal configuration. The candidate receiver node can determine a receiving beam direction, perform bi-static sensing measurements, and transmit an ACK or NACK response. For bi-static sensing transmitter switching, both the transmitting node and receiving node can be changed, with the source BS coordinating the handover to a target BS and corresponding receiver.

Sensing mode switching enables dynamic adaptation between mono-static, bi-static, and multi-static sensing modes based on sensing QoS key performance indicators (KPIs). A BS can monitor sensing KPIs such as latency, location accuracy, velocity accuracy, and ratio of correct detection to missed and false detection. When one or more sensing KPIs degrade below a threshold while operating in mono-static mode, the BS can switch to bi-static mode by identifying a candidate receiver node and transmitting a sensing mode switch request. The request message can include object position, velocity, Doppler frequency, micro-Doppler signature, sensing mode, and sensing reference signal (RS) configuration. Similarly, when operating in bi-static mode, if sensing KPIs degrade, the BS can switch to multi-static mode by adding additional receiver nodes.

The sensing handover request messages can be carried by RRC signaling, MAC-CE, DCI, or UCI, depending on whether the communication is between BSs or between a BS and a UE. For BS to BS communication, the messages can be carried over the Xn interface. By indicating a mobile object’s position, velocity, and Doppler frequency to a new node, the disclosed procedures can accelerate beam tracking in the new node without requiring full beam sweeping, thereby reducing sensing interruption time.

Accordingly, there may be an increased attention in the mobile wireless industry to introduce ISAC in beyond fifth generation (5G) standards, for applications such as traffic monitoring and safety, presence detection, localization, and mapping.

Sensing and communications may address different sets of use cases and requirements. In sensing, a known signal can be transmitted in a particular direction, and by analyzing the reflected signal, various parameters such as channel response, target presence, and target properties like position, shape, size, and velocity can be estimated. In contrast, in communication, key performance indicators can include data rate, latency, and reliability. This difference can lead to sensing signal characteristics such as bandwidth, time duration, periodicity, and power being different from those used for communication purposes.

Multiple technological areas can benefit from 5G-Advanced-based sensing services, including intelligent transportation, aviation, enterprise, smart city, smart home, smart factories, consumer applications, and the public sector. Sensing wireless systems that may rely on the same 5G new radio (NR) wireless communication system and infrastructure can provide sensing information that can be utilized to assist wireless communication functionalities, such as radio resource management, interference mitigation, beam management, and mobility. Higher efficiency for both sensing services and sensing-assisted communications can be enabled when wireless sensing and communication may be integrated in the same wireless channel or environment.

Several use cases can benefit from ISAC. For outdoor smart transportation, a first use case can involve perception of blind spots in road traffic areas. The blind spot of a vehicle may refer to an area where the line of sight may be blocked by obstacles or the vehicle itself and may not be directly observed by the driver. Many sub-use cases may exist, particularly relating to heavy vehicles whose large blind spots can cause traffic accidents. A second use case can involve perception of road dynamic information, which can be classified into traffic congestion detection and traffic safety risk detection. Severe traffic congestion can reduce travel efficiency, impact people’s lives, limit manufacturing production, increase air pollution, and negatively affect people’s health. Traffic safety risk detection may relate to dangerous driving behaviors such as speeding, sharp turning, sudden acceleration, and sudden braking.

For indoor smart life applications, a third use case can involve contactless respiration monitoring. Respiratory diseases suffered worldwide may incur a large global health burden, particularly for vulnerable infants and young children. Human sleep situations can be monitored with wireless signals. A fourth use case can involve gesture recognition. Gesture recognition can be more flexible to express meanings from the human body, such as from the head, hand, leg, and combinatorial human body parts. Two types of schemes may exist for gesture recognition: device-based and device-free, corresponding to wearable devices and non-wearable devices, respectively. Sensors for device-based solutions can include cameras, depth cameras, gloves, and wristbands, while sensors for device-free solutions can include radar.

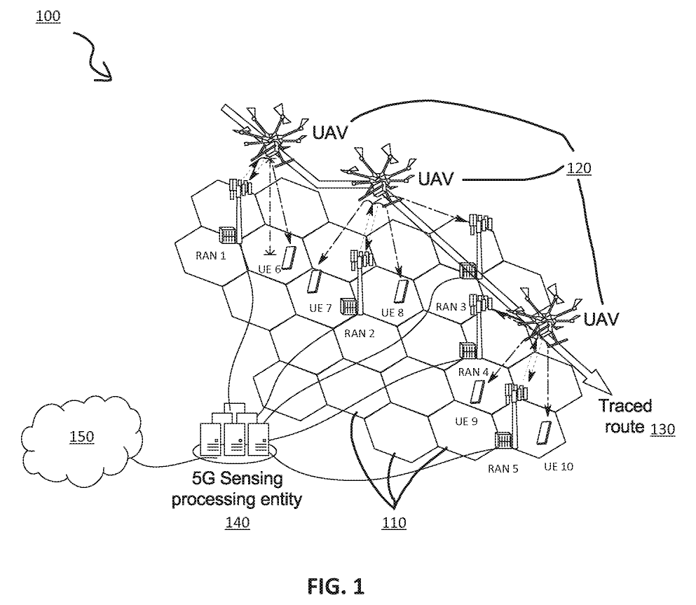

FIG. 1 may illustrate a wireless communication system including UAV flight trajectory tracking, according to embodiments of this disclosure.

Referring to FIG. 1, the system 100 may include multiple BS radio access networks (RANs), which can be gNBs or other types of BSs. These BSs are illustrated as RAN 1-RAN 5. The system 100 may also include multiple UEs distributed throughout a coverage area. These UEs are illustrated as UE 6-UE 10. The coverage area can be divided into multiple cells 110, where each cell may represent a geographic region served by one or more BSs. A single UAV 120 may be shown following a traced route 130, which may represent a predetermined flight path or trajectory. The system 100 may also include a sensing processing entity 140.

The UAV 120 may be a commercial UAV used for package delivery, aerial photography, environmental monitoring, or public security. The UAV 120 can fly based on predetermined flight routes, following regulated positions, heights, speeds, and directions. A UAV 120 may be equipped with sensors to keep itself along the flight route, but external UAV flight trajectory tracing functions can be beneficial because these sensors can be restricted. For example, cameras can be impacted by light conditions, and UAV-borne radar can be impacted by rainfall or snowfall. If these events occur, the UAV 120 may not correctly determine its own position, height, or speed, and thus may not follow the traced route 130.

Dedicated UAV surveillance equipment and radar may exist, but large-scale deployment of such equipment can face challenges due to lack of available sites and high installation and maintenance costs. Using a 5G system can provide a cost-effective way to track UAVs. For example, 5G network infrastructures with ubiquitous coverage can track the flight trajectory of UAV 120. RAN entities 1-5, such as the BSs, can rely on radio sensing to obtain information on UAV position and motion, such as distance and angle, and can transmit sensing data to the sensing processing entity 140 located in the 5G system.

The sensing processing entity 140 can collect sensing data from one or multiple network infrastructures. A 5G network operator can provide UAV flight trajectory tracing service to a trusted third-party application, such as a UAV service operator, UAV management department, or uncrewed aerial system (UAS) service supplier (USS)/uncrewed aerial system traffic management (UTM) 150, as requested. Service requirements can include that the 5G system shall be able to provide means for supporting sensing service continuity. In addition, the 5G system shall support energy efficient sensing operations. Examples of energy efficient sensing operations can include temporarily disabling sensing transmitters and receivers that may not be involved in sensing and communication operations.

Cell sizes (e.g., of cell 110) for cellular deployment can be relatively small, in the order of one kilometer or less. UAVs can move at relatively fast speeds and thus can move from one cell to another cell relatively frequently. Multi-cell or multi-node sensing with continuous sensing can be beneficial, where the sensing procedure may not be interrupted when the UAV 120 moves from one cell to another cell. A mobility management scheme for sensing, with cooperation of multiple BSs and UEs in adjacent cells, can address this need.

Schemes for sensing node switching can be utilized. Sensing node switching may indicate a UAV position, speed, or Doppler frequency to a new node, which can accelerate beam tracking in the new node and reduce interruption to sensing. Multi-cell sensing to support wide-area coverage of UAV monitoring can utilize continuous sensing that may rely on consistent cooperation of multiple BSs or UEs in adjacent cells. Sensing handover schemes can be implemented for different use cases, such as different types of sensing node switching. For instance, mono-static sensing node switching, bi-static sensing node switching (such as bi-static sensing receiver switching or bi-static sensing transmitter switching), or multi-static sensing node switching can be utilized.

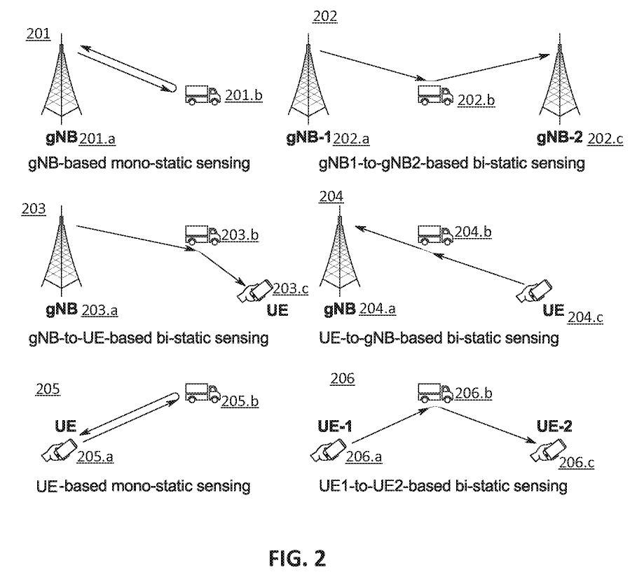

FIG. 2 may illustrate various sensing mode configurations, according to embodiments of this disclosure.

Referring to FIG. 2, as shown in a first configuration 201, mono-static sensing may refer to a configuration where a single node 201.a may transmit a sensing signal and may receive the reflected sensing signal from an object 201.b. The first configuration 201 may show BS-based mono-static sensing (gNB-based mono-static sensing), where a BS 201.a may perform both transmission sensing signals and reception of reflected signals.

As shown in a second configuration 202, bi-static sensing may refer to a configuration where one node 202.a may transmit a sensing signal and a different node 202.c may receive the sensing signal reflected from an object 202.b. The second configuration 202 may show BS-to-BS bi-static sensing (gNB1-to-gNB2-based bi-static sensing), where a first BS 202.a may transmit sensing signals and a second BS 202.c may receive a reflected signals.

As shown in a third configuration 203, the third configuration 203 may show BS-to-UE bi-static sensing (gNB-to-UE-based bi-static sensing), where a BS 203.a may transmit sensing signals and a UE 203.c may receive signals reflected from an object 203.b.

As shown in a fourth configuration 204, the fourth configuration 204 may show UE-to-BS bi-static sensing (UE-to-gNB-based bi-static sensing), where a UE 204.c may transmit sensing signals and a BS 204.a may receive signals reflected from an object 204.b.

As shown in a fifth configuration 205, the fifth configuration 205 may show UE-based mono-static sensing, where a single UE 205.a may perform both transmission of sensing signals and reception of signals reflected from an object 205.b.

As shown in a sixth configuration 206, the sixth configuration 206 may show UE-to-UE bi-static sensing (UE1-to-UE2-based bi-static sensing), where a first UE 206.a may transmit sensing signals and a second UE 206.c may receive signals reflected from an object 206.b.

Multi-static sensing may refer to a configuration where multiple nodes may be involved in the sensing operation. For example, one node can transmit while multiple nodes receive, or multiple nodes can transmit while one or more nodes receive. Various combinations of the configurations shown in FIG. 2 can be utilized to implement multi-static sensing.

Switching between different sensing modes while a mobile target may be moving across different propagation conditions with different sensing QoS conditions can be beneficial. Different sensing modes can include mono-static sensing, bi-static sensing, or multi-static sensing. For example, for a given sensing QoS KPI target, when there may be a LOS condition between a sensing transmitter and a mobile target (e.g., when there is a direct unobstructed path), it may be sufficient to use mono-static sensing mode such that network resources for sensing can be minimized. When there may be an NLOS condition between a sensing transmitter and a mobile target (e.g., when there is not a direct unobstructed path), bi-static sensing mode or multi-static sensing mode may be used to achieve the required sensing QoS KPI.

Embodiments of this disclosure provide signaling systems and methods to enable sensing node switching for ISAC in mobile environments with minimum sensing interruptions, such that sensing quality of service can be maintained. Embodiments of this disclosure also provide signaling and methods to enable sensing mode switching between mono-static, bi-static, and multi-static sensing, to achieve desired sensing quality of service.

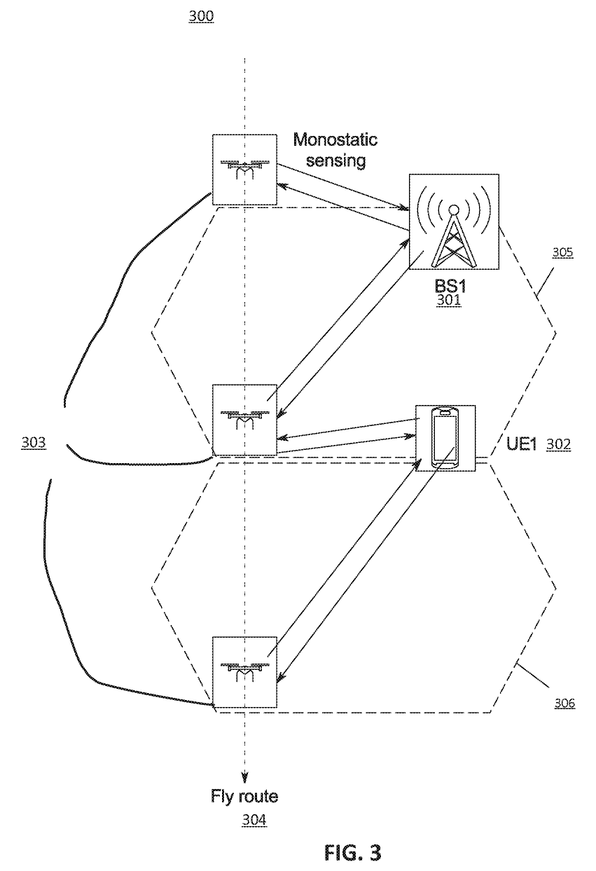

FIG. 3 may illustrate a mono-static sensing node switching scheme in a wireless communication system, according to embodiments of this disclosure.

Referring to FIG. 3, the scheme 300 may show a scenario where mono-static sensing responsibilities are transferred from a first BS (BS1) 301 to a first UE (UE1) 302 as an object 303, such as a UAV, moves along a flight route 304. The system may include multiple cells 305 and 306. A first cell 305 may include BS1 301, and a second cell 306 may include UE1 302.

As shown in FIG. 3, at a beginning of the flight route 304, BS1 301 may perform mono-static sensing by transmitting sensing signals toward the object 303 and receiving reflected signals back from the object 303. As the object 303 moves along the flight route 304, the quality of the reflected signals received at BS1 301 may degrade. At a middle portion of the flight route 304, the sensing node may switch from BS1 301 to UE1 302. The object 303 may receive sensing signals from BS1 301 or sensing signals from UE1 302 during a transition period. At an end of the flight route 304, UE1 302 may perform mono-static sensing by transmitting sensing signals toward the object 303 and receiving reflected signals back from the object 303.

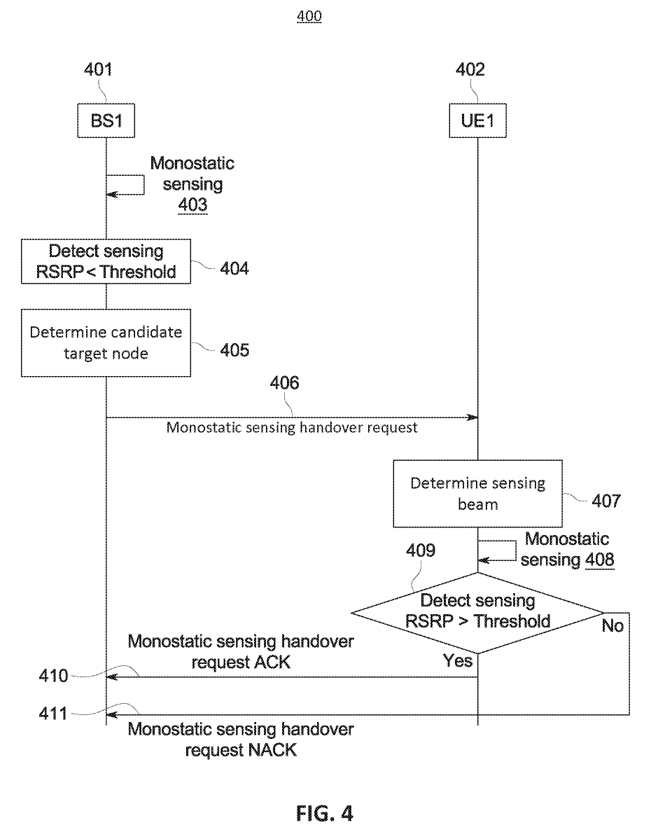

FIG. 4 may illustrate a communication flow diagram for mono-static sensing node switching between a BS and a UE, according to embodiments of this disclosure.

Referring to FIG. 4, the diagram 400 may show signaling between a first BS (BS1) 401 and a first UE (UE1) 402.

At step 403, BS1 401 may perform mono-static sensing by transmitting a sensing signal to detect an object, such as a UAV, and may receive a sensing signal reflected back from the object. At step 404, BS1 401 may detect whether a sensing RSRP is less than a threshold. The sensing RSRP may refer to the power of the reflected sensing signal received at BS1 401. When the sensing RSRP falls below the threshold, this may indicate that the object is moving away from BS1 401 or that propagation conditions have degraded.

At step 405, BS1 401 may determine or identify a candidate target node (UE1 402) to perform mono-static sensing based on the object’s position and velocity. The candidate target node can be UE1 402. BS1 401 may determine the object’s position and velocity by analyzing the reflected sensing signals, which can include estimating distance, angle, and Doppler frequency. Based on this information, BS1 401 can identify UE1 402 as a suitable candidate for taking over the mono-static sensing operation by determining, for example, that UE1 402 is located closer to the UAV than BS1 401.

At step 406, BS1 401 may transmit a mono-static sensing handover request to UE1 402. The mono-static sensing handover request may include a number of parameters or measurements. The parameters can include an object ID, which may uniquely identify the object being tracked. The parameters can include object position information, which may specify the current location of the object in three-dimensional space. The parameters can include object velocity information, which may specify the speed and direction of the object’s movement. The parameters can include Doppler frequency information, which may characterize the frequency shift of the reflected signals due to the object’s motion. The parameters can include micro-Doppler signature information, which may characterize additional motion characteristics of the object, such as rotation of propellers or other moving parts.

At step 407, UE1 402 may receive the mono-static sensing handover request that includes the parameters or measurements and determine or select a sensing beam based on the object position information. The sensing beam determination can involve selecting a transmit beam direction and a receive beam direction that point toward the expected location of the object. By using the object position information provided by BS1 401, UE1 402 can avoid performing a full beam sweep and can direct sensing signals toward the object.

At step 408, UE1 402 may transmit a sensing signal to detect the object and may receive a sensing signal reflected back from the object. UE1 402 may perform mono-static sensing measurements by analyzing the reflected signal.

At step 409, UE1 402 may detect whether a sensing RSRP is greater than a threshold. If the sensing RSRP measured by UE1 402 exceeds the threshold, this may indicate that UE1 402 can successfully perform mono-static sensing for the object with sufficient signal quality.

At step 410, UE1 402 may transmit a mono-static sensing handover request ACK to BS1 401 in case the detected sensing RSRP is greater than the threshold. The ACK message may include a number of parameters or measurements, such as the sensing RSRP measured by UE1 402. If UE1 402 transmits an ACK, this may indicate that UE1 402 has successfully taken over the mono-static sensing operation. If the detected sensing RSRP is less than or equal to the threshold, then the UE1 402 may transmit a NACK in step 411, and this may indicate that UE1 402 cannot perform the mono-static sensing operation with sufficient quality, and BS1 401 may need to identify a different candidate node.

The mono-static sensing handover request message can be carried by a UE-specific RRC message, a MAC-CE, or DCI from BS1 401 to UE1 402. The choice of signaling method can depend on factors such as latency requirements, message size, and network configuration.

BS1 401 may measure other parameters in addition to RSRP or RSRQ of the reflected sensing signal. For example, BS1 401 can measure other sensing KPIs that influence sensing QoS, such as latency, location accuracy, velocity accuracy, or ratio of correct detection to missed and false detection. If one or more of those sensing KPIs degrade below a threshold value, the sensing handover request message may be triggered.

BS1 401 may send a mono-static sensing handover request to multiple candidate UEs. One or more UEs may send a response message back to BS1 401. BS1 401 may then select and confirm one of the UEs by sending a confirmation message to the selected UE. In this case, the mono-static sensing handover request can be carried in a system information block 1 (SIB1) or another system information block message that can be broadcast to all UEs served by BS1 401.

In cases where UE1 402 is served by a different BS than BS1 401, BS1 401 may send the mono-static sensing handover request first to the serving BS of UE1 402 via an Xn interface between BS1 401 and the serving BS. The serving BS may then forward the request message to UE1 402. Similarly, UE1 402 may first send the response message to its serving BS, and the serving BS may forward the response message from UE1 402 to BS1 401.

The information elements (IEs) in the sensing handover request message (also referred to as the sensing handover request message) may include the object ID, which may uniquely identify the object being tracked. The IEs may include object location information, which may specify the position of the object in a coordinate system. The IEs may include velocity information, which may specify the speed and direction of the object’s movement. The IEs may include micro-Doppler signature information, which may characterize motion characteristics of the object beyond bulk translation, such as rotation, vibration, or other periodic movements. The micro-Doppler signature information may be used by a target sensing node to distinguish the mobile object from other nearby objects, and/or to improve tracking continuity when transferring sensing responsibilities between nodes.

The mono-static sensing handover request message from BS1 401 to UE1 402 may represent a signaling container for sensing handover operations. When UE1 402 is served by BS1 401, the message can be carried by an RRC message specifically designed for sensing handover requests. The message container may include the UAV ID, position, and velocity as parameters for enabling the sensing node switch.

UE1 402 may implement behaviors for handling mono-static sensing node switching. These behaviors can include determining a sensing beam based on the UAV position and velocity received in the switch request, performing mono-static sensing measurements using the determined beam, determining whether to acknowledge or negatively acknowledge the sensing handover request based on measured sensing quality metrics, and sending the ACK or NACK response to BS1 401. These behaviors may enable UE1 402 to take over sensing responsibilities from BS1 401 with minimal interruption to the continuous tracking of the UAV.

By indicating the object’s position, velocity, and Doppler frequency to UE1 402, the mono-static sensing node switching procedure can accelerate beam tracking in UE1 402. UE1 402 may not need to perform a full beam sweep to locate the object, which can reduce sensing interruption time. The object information can enable UE1 402 to immediately configure its sensing beams in a specific direction to allow seamless handover of the sensing operation.

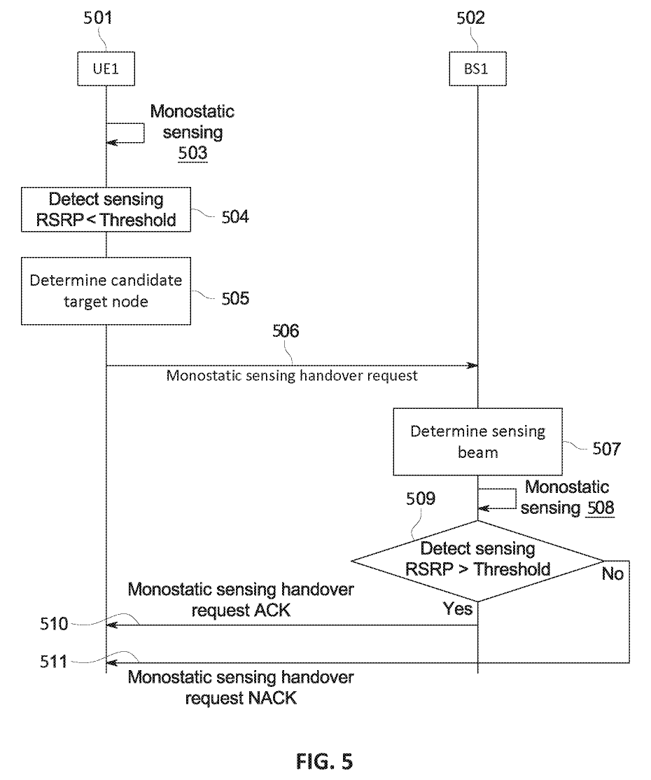

FIG. 5 may illustrate a communication flow diagram for mono-static sensing node switching between a UE and a BS, according to embodiments of this disclosure.

Referring to FIG. 5, the diagram 500 may show signaling between a first UE (UE1) 501 and a first BS (BS1) 502.

At step 503, UE1 501 may transmit a sensing signal to detect an object, such as a UAV, and may receive a sensing signal reflected back from the object. In step 504, UE1 501 may detect whether a sensing RSRP is less than a threshold.

At step 505, UE1 501 may determine or identify a candidate target node (BS1 502) to perform mono-static sensing based on the object’s position and velocity. The candidate target node can be BS1 502. UE1 501 may determine the object’s position and velocity by analyzing the reflected sensing signals, which can include estimating distance, angle, and Doppler frequency. Based on this information, UE1 501 can identify BS1 502 as a suitable candidate for taking over the mono-static sensing operation by determining, for example, that BS1 502 is located closer to the UAV than UE1 501.

At step 506, UE1 501 may transmit a mono-static sensing handover request to BS1 502. The request may include a number of parameters or measurements, such as UAV position, speed, Doppler frequency, micro-Doppler signature, or other sensing-related information.

At step 507, BS1 502 may receive the mono-static sensing handover request and determine or select a sensing beam based on the UAV position. At step 508, BS1 502 may transmit the sensing signal to detect the UAV and may receive a sensing signal reflected back from the UAV.

At step 509, BS1 502 may detect whether a sensing RSRP is greater than a threshold.

At step 510, BS1 502 may transmit a mono-static sensing handover request ACK to UE1 501 in case the detected sensing RSRP is greater than the threshold. The ACK message may include a number of parameters or measurements, such as the sensing RSRP measured by BS1 502. If BS1 502 transmits an ACK, this may indicate that BS1 502 has successfully taken over the mono-static sensing operation. If the detected sensing RSRP is less than or equal to the threshold, then the BS1 502 may transmit a NACK in step 511, and this may indicate that BS1 502 cannot perform the mono-static sensing operation with sufficient quality, and UE1 501 may need to identify a different candidate node.

The mono-static sensing handover request message can be carried by a UE-specific RRC message, a MAC-CE, or UCI from UE1 501 to BS1 502.

UE1 501 may measure other parameters in addition to RSRP or RSRQ of the reflected sensing signal. For example, UE1 501 can measure other sensing KPIs that influence sensing QoS, such as latency, location accuracy, velocity accuracy, or ratio of correct detection to missed and false detection. If one or more of those sensing KPIs degrade below a threshold value, the sensing handover request message may be triggered.

UE1 501 may send a mono-static sensing handover request to multiple candidate BSs or UEs. One or more BSs or UEs may send a response message back to UE1 501. UE1 501 may then select and confirm one of the BSs or UEs by sending a confirmation message to the selected BS or UE. The mono-static sensing handover request can be sent individually to each candidate BS or candidate UE.

In cases where BS1 502 is not the serving BS of UE1 501, UE1 501 may send the mono-static sensing handover request first to its serving BS. The serving BS may then forward the request message to BS1 502 via an Xn interface. Similarly, BS1 502 may first send the response message to UE1 501’s serving BS, and the serving BS may forward the response message from BS1 502 to UE1 501.

The IEs in the sensing handover request message may include the object ID, which may uniquely identify the object being tracked. The IEs may include object location information, which may specify the position of the object in a coordinate system. The IEs may include velocity information, which may specify the speed and direction of the object’s movement. The IEs may include micro-Doppler signature information, which may characterize motion characteristics of the object beyond bulk translation, such as rotation, vibration, or other periodic movements.

The mono-static sensing handover request message from UE1 501 to BS1 502 may represent a signaling container for UE-initiated sensing handover operations. When UE1 501 is served by BS1 502, the message can be carried by an RRC message specifically designed for sensing handover requests. The message container may include the UAV ID, position, and velocity as parameters for enabling the sensing node switch.

BS1 502 may implement behaviors for handling mono-static sensing node switching. These behaviors can include determining a sensing beam based on the UAV position and velocity received in the switch request, performing mono-static sensing measurements using the determined beam, determining whether to acknowledge or negatively acknowledge the sensing handover request based on measured sensing quality metrics, and sending the ACK or NACK response to UE1 501. These behaviors may enable BS1 502 to take over sensing responsibilities from UE1 501 with minimal interruption to the continuous tracking of the UAV.

By indicating the object’s position, velocity, and Doppler frequency to BS1 502, the mono-static sensing node switching procedure can accelerate beam tracking in BS1 502. BS1 502 may not need to perform a full beam sweep to locate the object, which can reduce sensing interruption time. The object information can enable BS1 502 to immediately configure its sensing beams in a specific direction to allow seamless handover of the sensing operation.

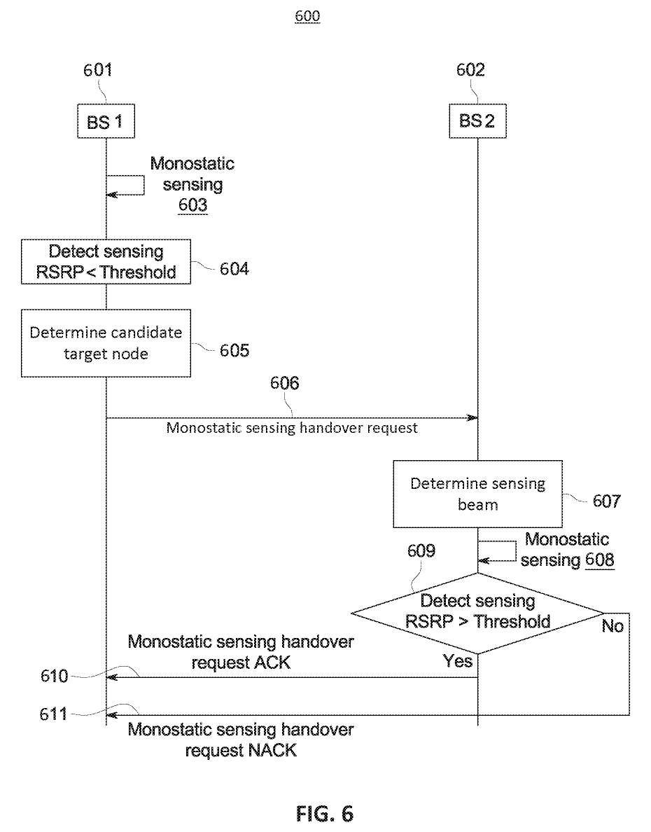

FIG. 6 may illustrate a communication flow diagram for mono-static sensing node switching between BSs, according to embodiments of this disclosure.

Referring to FIG. 6, the diagram 600 may show signaling between a first BS (BS1) 601 and a second BS (BS2) 602.

At step 603, BS1 601 may transmit a sensing signal to detect an object, such as a UAV, and may receive a sensing signal reflected back from the object. At step 604, the BS1 601 may detect whether a sensing RSRP is less than a threshold.

At step 605, BS1 601 may determine or identify a candidate target node (BS2 602) to perform mono-static sensing based on the object’s position and velocity. The candidate target node can be BS2 602. BS1 601 may determine the object’s position and velocity by analyzing the reflected sensing signals, which can include estimating distance, angle, and Doppler frequency.

Based on this information, BS1 601 can identify BS2 602 as a suitable candidate for taking over the mono-static sensing operation by determining, for example, that BS2 602 is located closer to the UAV than BS1 601.

At step 606, BS1 601 may transmit a mono-static sensing handover request to BS2 602. The request may include a number of parameters or measurements, such as UAV position, speed, Doppler frequency, micro-Doppler signature, or other sensing-related information.

At step 607, BS2602 may receive the mono-static sensing handover request and determine or select a sensing beam based on the UAV position. At step 608, BS2602 may transmit the sensing signal to detect the UAV and may receive a sensing signal reflected back from the UAV.

At step 609, BS2 602 may detect whether a sensing RSRP is greater than a threshold.

At step 610, BS2 602 may transmit a mono-static sensing handover request ACK to BS1 601 in case the detected sensing RSRP is greater than the threshold. The ACK message may include a number of parameters or measurements, such as the sensing RSRP measured by BS2 602. If BS2 602 transmits an ACK, this may indicate that BS2 602 has successfully taken over the mono-static sensing operation. If the detected sensing RSRP is less than or equal to the threshold, then the BS2 602 may transmit a NACK in step 611, and this may indicate that BS2 602 cannot perform the mono-static sensing operation with sufficient quality, and BS1 601 may need to identify a different candidate node.

The mono-static sensing handover request message from BS1 601 to BS2 602 can be carried via an Xn interface between the BSs. The Xn interface may provide a standardized communication path for inter-BS signaling in wireless networks.

By indicating the UAV position, speed, and Doppler frequency from BS1 601 to BS2 602, the mono-static sensing node switching procedure can accelerate beam tracking in BS2 602. BS2 602 may not need to perform a full beam sweep to locate the object, which can reduce sensing interruption time.

In ISAC systems, there may be two distinct handover processes: handover for sensing service and handover for communications, with different triggering events and RSRP or RSRQ thresholds. The sensing handover procedure described herein may focus on handover for sensing service, independent of handover for communications. Handover for communication may occur as well, but may be an independent process with separate triggering conditions and procedures.

The mono-static sensing handover request message from BS1 601 to BS2 602 may represent a signaling container for BS-to-BS sensing handover operations. The message container may include the UAV ID, position, and velocity as parameters for enabling the sensing node switch. The measurements and detection operations performed by BS1 601 and BS2 602 can address how BSs assess sensing signal quality and determine handover decisions.

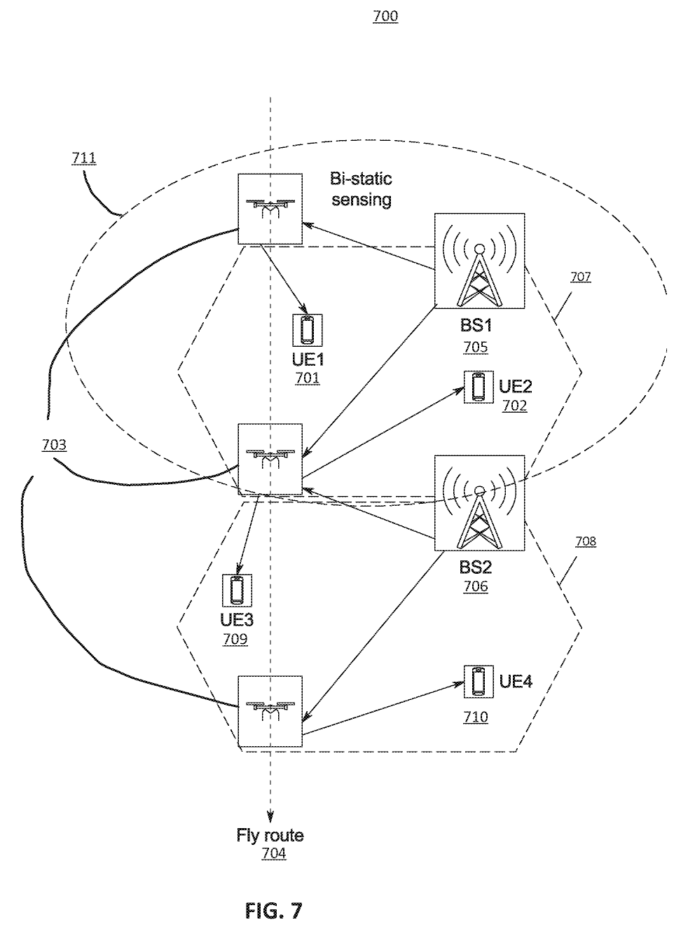

FIG. 7 may illustrate a bi-static sensing receiver node switching scheme in a wireless communication system, according to embodiments of this disclosure.

Referring to FIG. 7, the scheme 700 may show a scenario where bi-static sensing receiver responsibilities are transferred from UE1 701 to a second UE2 702 as an object 703, such as a UAV, moves along a flight route 704. The system may include a first BS1 705 and may also include a second BS2 706. A first cell 707 may be associated with BS1 705, and a second cell 708 may be associated with BS2 706. UE1 701 and UE2 702 may be located within the first cell 707. A third UE3 709 and a fourth UE4 710 may be located within the second cell 711.

As shown in FIG. 7, at a beginning of the flight route 704 in the upper portion of the dashed oval 711, BS1 705 may transmit sensing signals to the UAV 703. The sensing signals may be detected and received by UE1 701. As the UAV 703 moves further along the flight route 704, such as in the lower portion of the dashed oval 711, the sensing signal receiving node may be switched from UE1 701 to UE2 702 to receive the reflected sensing signal from the UAV 703. The handover from UE1 701 to UE2 702 can occur while BS1 705 continues to transmit sensing signals. Therefore, the receiving node may be switched in the bi-static sensing scheme 700 as the UAV 703 travels through the area designated by the oval 711.

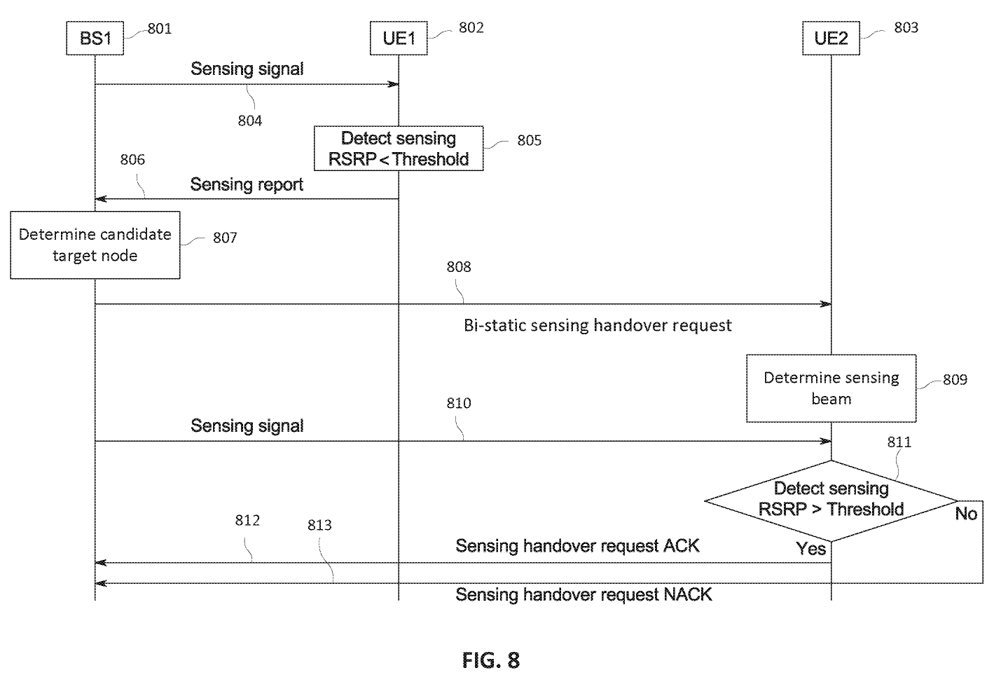

FIG. 8 may illustrate a communication flow diagram for bi-static sensing receiver node switching, according to embodiments of this disclosure.

Referring to FIG. 8, the diagram 800 may show signaling between a BS1 801, a first UE1 802, and a second UE2 803.

At step 804, BS1 801 may transmit a sensing signal to UE1 802.

At step 805, UE1 802 may detect whether a sensing RSRP is less than a threshold. UE1 802 may transmit a sensing report to BS1 801 at step 806. The sensing report may include the sensing RSRP or other sensing quality metrics.

At step 807, BS1 801 may determine or identify a candidate target UE based on the UAV position. BS1 801 can identify UE2 803 as a candidate receiver for the bi-static sensing operation based on the UAV’s position and velocity. For example, the candidate receiver node may be selected as a UE whose location is closer to the UAV than the current receiver.

At step 808, BS1 801 may transmit a bi-static sensing receiver request to UE2 803. The request may include a number of parameters or measurements, such as UAV position, speed, Doppler frequency profile, sensing signal configuration, or other sensing-related information.

At step 809, UE2 803 may receive the bi-static sensing receiver request, and UE2 803 may determine or select a sensing beam based on the UAV position.

At step 810, BS1 801 may transmit a sensing signal to UE2 803.

At step 811, UE2 803 may detect whether a sensing RSRP is greater than a threshold.

At step 812, UE2 803 may transmit a bi-static sensing receiver request ACK to the BS1 801 if the RSRP is greater than a threshold. If the RSRP is less than or equal to the threshold, the UE2 803 may transmit a NACK to BS1 801 in step 813.

UE1 802 may measure other parameters in addition to RSRP or RSRQ of the received sensing signal and compare it to a threshold in step 805. For example, UE1 802 can measure other sensing KPIs that influence sensing QoS, such as latency, location accuracy, velocity accuracy, or ratio of correct detection to missed and false detection. If one or more of those sensing KPIs degrade below a threshold value, the sensing receiver switch report may be triggered by UE1 802. For instance, if the location accuracy falls below a threshold (or out of a range), the sensing switch report may be triggered by UE1 802.

The bi-static sensing receiver request message from BS1 801 to UE2 803 in step 808 may represent a signaling container for bi-static sensing receiver handover operations. When UE2 803 is served by BS1 801 in step 808, the message can be carried by an RRC message. The message container may include the UAV ID, position, velocity, micro-Doppler signature, and sensing signal measurement configuration.

UE2 803 may implement behaviors for handling bi-static sensing receiver switching. These behaviors can include determining a sensing beam based on UAV position and velocity, performing bi-static sensing measurements, determining whether to acknowledge or negatively acknowledge the sensing handover request, and sending the ACK or NACK to BS1 801. These behaviors may enable UE2 803 to take over sensing receiver responsibilities from UE1 802 with minimal interruption to the continuous tracking of the UAV.

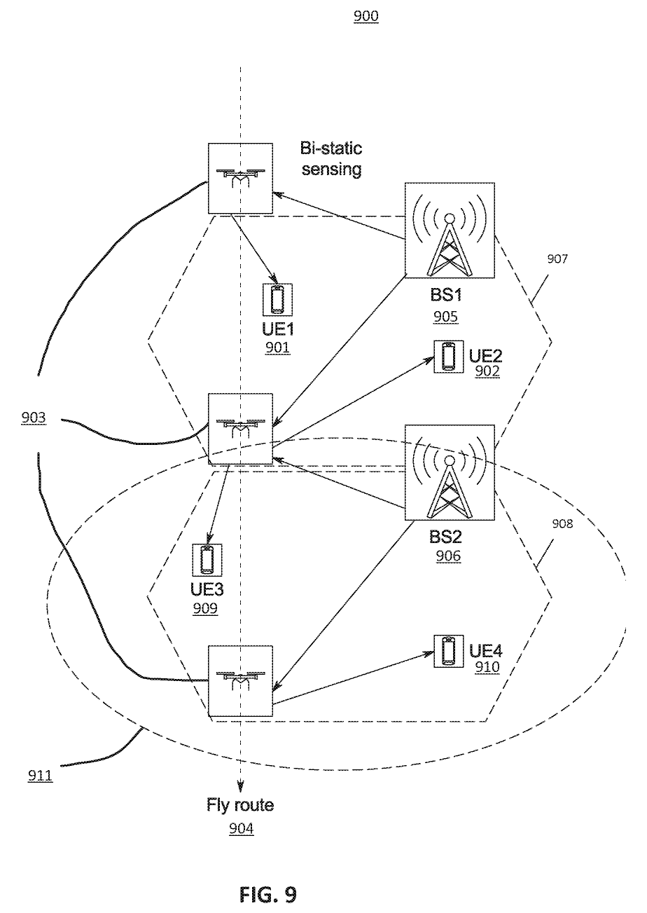

FIG. 9 may illustrate a bi-static sensing transmitter and receiver node switching scheme in a wireless communication system, according to embodiments of this disclosure.

The scheme 900 may show a scenario where both bi-static sensing transmitter and receiver nodes are switched as an object 903, such as a UAV, moves along a flight route 904. The system may include a first BS1 905, a second BS2 906, a first UE1 901, a second UE2 902, a third UE3 909, and a fourth UE4 910. A first cell 907 may be associated with BS1 905 and may include UE1 901 and UE2 902. A second cell 908 may be associated with BS2 906 and may include UE3 909 and UE4 910.

As shown in FIG. 9, at a middle portion of the flight route 904 in the upper edge of the dashed oval 911, BS1 905 may transmit sensing signals to the UAV 903. The sensing signals may be detected and received by UE2 902. As the UAV 903 moves further along the flight route 904, such as from the upper portion of the oval 911 to a lower portion of the oval 911, the sensing signal transmitter node may be switched from BS1 905 to BS2 906 for better detecting the UAV 903. Also, while the UAV 903 moves further along the flight route 904, such as from the upper portion of the oval 911 to the lower portion of the oval 911, the sensing signal receiver node may be switched from UE3 909 to UE4 910 for receiving the reflected sensing signal from the UAV 903. Therefore, both the transmitting and receiving nodes may be switched in the bi-static sensing scheme 900 as the UAV 903 enters and travels through the area designated by the oval 911.

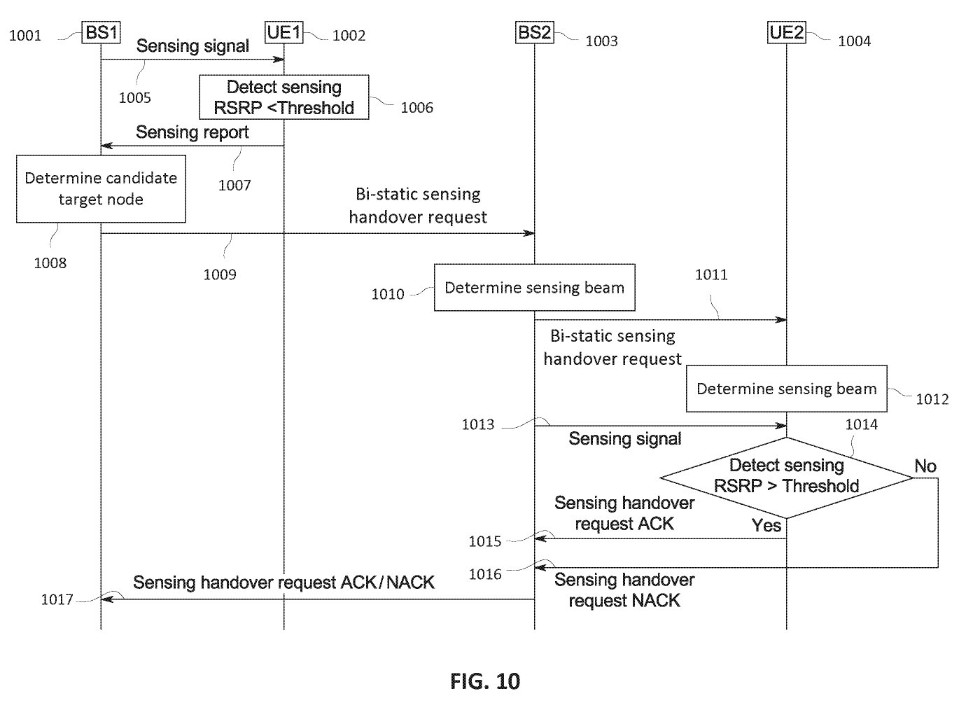

FIG. 10 may illustrate a communication flow diagram for bi-static sensing transmitter and receiver node switching, according to embodiments of this disclosure.

Referring to FIG. 10, the diagram 1000 may show signaling between a first BS1 1001, a first UE1 1002, a second BS2 1003, and a second UE2 1004.

At step 1005, BS1 1001 may transmit a sensing signal to UE1 1002.

At step 1006, UE1 1002 may detect whether a sensing RSRP is less than a threshold. UE1 1002 may transmit a sensing report to BS1 1001 in step 1007. The sensing report may include the sensing RSRP or other sensing quality metrics.

At step 1008, BS1 1001 may determine or identify a candidate transmitter node based on the UAV position. The candidate transmitter node can be a BS. BS1 1001 can identify BS2 1003 as a suitable candidate transmitter for the bi-static sensing operation based on, for example, the UAV position. For example, the candidate transmitter node may be selected as a BS whose location is closer to the UAV than the current transmitter.

At step 1009, BS1 1001 may transmit a bi-static sensing transmitter request to BS2 1003. The request may include a number of parameters or measurements, such as UAV position, speed, Doppler frequency profile, sensing signal configuration, or other sensing-related information.

At step 1010, BS2 1003 may receive the bi-static sensing transmitter request, and determine or select a sensing beam based on the UAV position and velocity. Based on parameters of the sensing beam (such as UAV position and/or velocity), BS2 1003 may select UE2 1004 as the sensing receiver and may transmit or forward the bi-static sensing handover request from BS1 1001 to UE2 1004 in step 1011.

At step 1012, UE2 1004 may determine or select a beam that is the sensing receiver beam direction based on the UAV position and velocity.

At step 1013, BS2 1003 may transmit a sensing signal to UE2 1004.

At step 1014, UE2 1004 may detect whether a sensing RSRP is greater than a threshold.

At step 1015, UE2 1004 may transmit a bi-static sensing receiver request ACK to BS2 1003 if the detected sensing RSRP is greater than the threshold. If the detected sensing RSRP is less than or equal to the threshold, the UE2 1004 may transmit a NACK to BS2 1003. BS2 1003 may transmit the bi-static sensing receiver request ACK or NACK to BS1 1001 in step 1017.

Furthermore, if UE2 1004 transmitted an ACK to BS2 1003, UE2 1004 may also transmit a sensing report to BS2 1003. The sensing report may include a number of parameters or measurements, such as sensing RSRP or other sensing quality metrics.

The bi-static sensing transmitter request message transmitted from BS1 1001 to BS2 1003 in step 1009 can be carried via an Xn interface between the BSs. BS2 1003 may then forward or transmit information from the request to UE2 1004 using an RRC message, a MAC-CE, or DCI.

The bi-static sensing transmitter and receiver node switching procedure may involve coordination between multiple nodes. For example, BS1 1001 may transmit the bi-static sensing transmitter node handover request including the UAV position, speed, Doppler frequency profile, and sensing signal configuration to BS2 1003 (step 1009). BS2 1003 may select UE2 1004 as the sensing receiver and may transmit or forward the bi-static sensing handover request from BS1 1001 to UE2 1004 (via step 1011). UE2 1004 may determine a beam that is the sensing receiver beam direction based on the UAV position and velocity (in step 1012). UE2 1004 may detect whether a sensing signal RSRP is greater than a threshold (in step 1014), and may transmit the sensing handover request ACK (in step 1015) or NACK (in step 1016) to BS2 1003, which may then forward the response to BS1 1001.

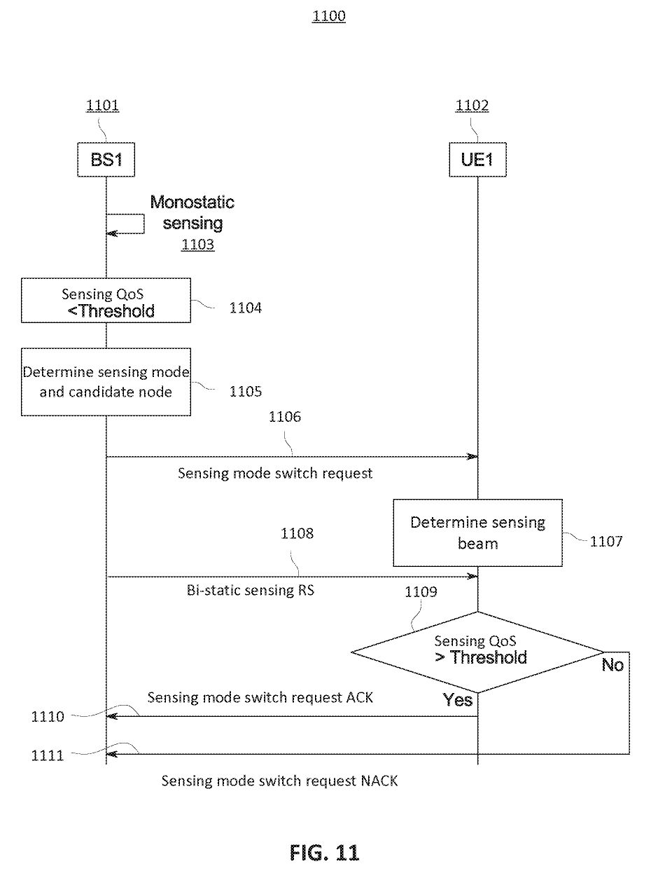

FIG. 11 may illustrate a communication flow diagram for sensing mode switching from mono-static to bi-static sensing, according to embodiments of this disclosure.

Referring to FIG. 11, the diagram 1100 may show signaling between a BS (BS1) 1101 and a UE (UE1) 1102.

At step 1103, BS1 1101 may transmit a sensing signal to detect an object, such as a UAV, and may receive a sensing signal reflected back from the object. BS1 1101 may perform mono-static sensing operations.

At step 1104, BS1 1101 may detect whether one or more sensing QoS KPIs are less than a threshold. The sensing KPIs can include sensing latency, location accuracy, velocity accuracy, ratio of correct detection to missed and false detection, RSRP or RSRQ of the received sensing signal. If one or more sensing QoS KPIs fall below their respective thresholds, this may indicate that the current mono-static sensing mode is insufficient to meet the required sensing performance.

At step 1105, BS1 1101 may determine a sensing mode and a candidate node based on the UAV position. BS1 1101 can determine that bi-static sensing mode may be more suitable than mono-static sensing mode for the current propagation conditions. BS1 1101 may identify a candidate sensing receiver node to perform bi-static sensing instead of mono-static sensing. The candidate receiver node can be UE1 1102.

At step 1106, BS1 1101 may transmit a sensing mode switch request to UE1 1102. The sensing mode switch request may include a number of parameters or measurements, such as UAV position, speed, Doppler frequency, micro-Doppler signature, sensing mode, sensing RS configuration, or other sensing-related information. The sensing mode parameter may indicate that the requested mode is bi-static sensing. The sensing RS configuration may specify the characteristics of the sensing signals that BS1 1101 will transmit and that UE1 1102 is expected to receive.

At step 1107, UE1 1102 may receive the sensing mode switch request, and determine or select a sensing signal receiving beam based on the UAV position provided in the request.

At step 1108, BS1 1101 may transmit a sensing signal to detect the UAV. UE1 1102 may receive a sensing signal reflected from the UAV based on the sensing signal configuration received in the sensing mode switch request message (in step 1106). The system may now operate in bi-static sensing mode, where BS1 1101 transmits a sensing signal and UE1 1102 receives the sensing signal.

At step 1109, UE1 1102 may detect whether one or more sensing QoS KPIs are greater than a threshold.

At step 1110, UE1 1102 may transmit a sensing mode switch request ACK to the BS1 1101 if the one or more sensing QoS KPIs are greater than the threshold. If the one or more sensing QoS KPIs are less than or equal to the threshold, the UE1 1102 may transmit a NACK to BS1 1101. The ACK or NACK message may include a number of parameters or measurements, such as sensing RSRP or other sensing quality metrics. If UE1 1102 transmits an ACK, this may indicate that the bi-static sensing mode is successfully established and provides adequate sensing quality. If UE1 1102 transmits a NACK, this may indicate that the bi-static sensing mode cannot meet the required sensing QoS, and BS1 1101 may need to attempt a different configuration or identify a different receiver node.

The sensing mode switch request message transmitted from BS1 1101 to UE1 1102 in step 1106 may represent a signaling container for sensing mode switching operations. When UE1 1102 is served by BS1 1101, the message can be carried by an RRC message, a MAC-CE, or DCI.

UE1 1102 may implement behaviors and functions for handling sensing mode switching. These can include receiving the sensing mode handover request that includes parameters such as UAV position, speed, Doppler frequency, micro-Doppler signature, sensing mode, and sensing RS configuration from BS1 1101. UE1 1102 may measure the sensing signal and may determine whether one or more sensing QoS KPIs are greater than a threshold. UE1 1102 may transmit a sensing mode handover request ACK or NACK that includes parameters or measurements, such as sensing RSRP, to BS1 1101.

By switching from mono-static sensing to bi-static sensing based on sensing QoS KPIs, the system can adapt to changing propagation conditions. For example, when an LOS condition exists between BS1 1101 and the UAV, mono-static sensing may be sufficient. When an NLOS condition occurs, bi-static sensing may be necessary to maintain adequate sensing quality.

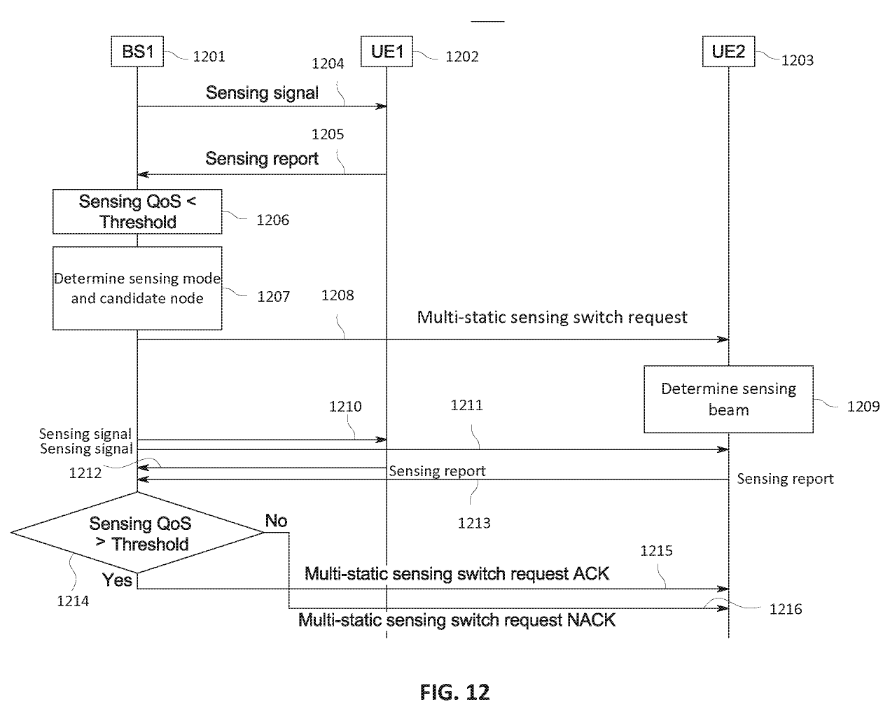

FIG. 12 may illustrate a communication flow diagram for sensing mode switching from bi-static to multi-static sensing, according to embodiments of this disclosure.

The diagram 1200 may show signaling between a BS (BS1) 1201, a first UE (UE1) 1202, and a second UE (UE2) 1203.

At step 1204, BS1 1201 may transmit a sensing signal to detect an object, such as a UAV. UE1 1202 may receive the sensing signal reflected back from the UAV. The system may initially operate in bi-static sensing mode, where BS1 1201 transmits a sensing signal and UE1 1202 receives a sensing signal.

At step 1205, UE1 1202 may transmit a sensing report to BS1 1201. The sensing report may include sensing quality metrics or measurements.

At step 1206, based on the sensing report from UE1 1202, BS1 1201 may determine whether one or more sensing QoS KPIs are less than a threshold. The sensing KPIs can include sensing latency, location accuracy, velocity accuracy, ratio of correct detection to missed and false detection, RSRP or RSRQ of the received sensing signal. If one or more sensing QoS KPIs fall below their respective thresholds, this may indicate that the current bi-static sensing mode is insufficient to meet the required sensing performance.

At step 1207, BS1 1201 may determine a sensing mode and candidate node based on the UAV position. BS1 1201 can determine that multi-static sensing mode may be more suitable than bi-static sensing mode for the current propagation conditions based on, for example, the UAV position, and the BS1 1201 may identify a candidate sensing receiver node (e.g., UE2 1203) to perform multi-static sensing instead of bi-static sensing.

At step 1208, BS1 1201 may transmit a multi-static sensing mode handover request to UE2 1203. The multi-static sensing mode handover request may include a number of parameters or measurements, such as UAV position, speed, Doppler frequency, micro-Doppler signature, sensing mode, sensing RS configuration, or other sensing-related information. The sensing mode parameter may indicate that the requested mode is multi-static sensing. The sensing RS configuration may specify the characteristics of the sensing signals that BS1 1201 will transmit and that both UE1 1202 and UE2 1203 are expected to receive.

At step 1209, UE2 1203 may receive the multi-static sensing mode handover request and determine or select a sensing signal receiving beam based on the UAV position provided in the request.

BS1 1201 may transmit a sensing signal to detect the UAV. UE1 1202 and/or UE2 1203 may receive the sensing signal reflected from the UAV. Step 1210 shows UE1 1202 receiving the sensing signal, and step 1211 shows UE2 1203 receiving the sensing signal. Accordingly, the system may now operate in multi-static sensing mode, where BS1 1201 transmits a sensing signal and multiple receivers (UE1 1202 and/or UE2 1203) receive the sensing signal.

At step 1212, UE1 1202 may transmit a sensing report to BS1 1201 based on a received sensing signal, and in step 1213 UE2 1203 may transmit a sensing report to BS1 1201 based on a received sensing signal. The sensing reports may include sensing quality metrics or measurements from each receiver.

At step 1214, BS1 1201 may determine whether one or more sensing QoS KPIs are greater than a threshold based on the sensing reports from UE1 1202 and UE2 1203. BS1 1201 can evaluate whether the multi-static sensing mode provides sufficient sensing quality by combining or analyzing the reports from UE1 1202 and/or UE2 1203.

If the sensing QoS is greater than the threshold, then in step 1215, BS1 1201 may transmit a multi-static sensing mode handover request ACK to UE2 1203, if the sensing QoS is less than or equal threshold, then the BS1 1201 may transmit a multi-static sensing mode handover request NACK to UE2 1203.

The ACK or NACK messages may include a number of parameters or measurements, such as sensing RSRP or other sensing quality metrics. If BS1 1201 transmits an ACK, this may indicate that the multi-static sensing mode is successfully established and provides adequate sensing quality. If BS1 1201 transmits a NACK, this may indicate that the multi-static sensing mode cannot meet the required sensing QoS, and BS1 1201 may need to attempt a different configuration.

The multi-static sensing mode switch request message from BS1 1201 to UE2 1203 (in step 1208) may represent a signaling container for multi-static sensing mode switching operations. When UE2 1203 is served by BS1 1201, the message can be carried by an RRC message, a MAC-CE, or DCI.

By switching from bi-static sensing to multi-static sensing based on sensing QoS KPIs, the system can provide spatial diversity and improved sensing coverage compared to bi-static sensing alone. When a single receiver in bi-static mode cannot maintain adequate sensing quality, adding additional receivers in multi-static mode can improve sensing coverage while achieving predefined sensing QoS, using a minimum number of nodes necessary to meet sensing requirements.

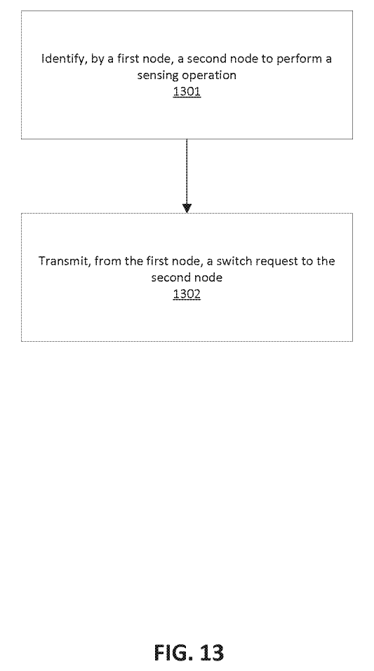

FIG. 13 is a flowchart illustrating a method for sensing node or mode switching in an ISAC system, according to embodiments of this disclosure.

Referring to FIG. 13, in step 1301, the method may include identifying, by a first node, a second node to perform a sensing operation based on a position or velocity of a mobile object. For example, the mobile object may be UAV moving along a flight route, and the first node may identify the second node as a candidate sensing node because the UAV position and/or velocity may indicate that the second node is expected to provide improved sensing continuity (e.g., improved LOS likelihood, shorter propagation distance, improved reflection geometry, or improved sensing QoS) as the UAV moves. Additionally, a base station (e.g., BS1) that is currently performing (or coordinating) sensing may determine that the UAV is moving toward the coverage region of a UE (e.g., UE2), and may identify UE2 as the second node based on the UAV position and/or velocity indicating that UE2 is likely to maintain a stronger sensing return or otherwise better satisfy one or more sensing KPIs while the UAV continues moving.

In step 1302, the method may include transmitting, from the first node, a switch request to the second node, wherein the switch request comprises the position or velocity of the mobile object. In one example, after BS1 identifies UE2 in step 1301, BS1 may transmit a sensing switch request to UE2 that includes at least the UAV position and/or velocity, such that UE2 may use the UAV position/velocity to determine sensing information, such as selecting or refining a sensing beam direction toward the UAV and preparing to perform a sensing operation with reduced interruption. In another example, where the second node is a base station (e.g., BS2), the first node may transmit the switch request over a node interface (or via an intermediate serving node,) while still including the UAV position and/or velocity in the switch request so that the second node can align its sensing resources to the expected UAV location and motion. In these examples, the switch request may be carried in higher-layer or lower-layer signaling (e.g., a UE-specific RRC message, a MAC-CE, DCI, UCI, or an inter-node message), and may further include additional information elements consistent with the sensing mobility procedures described herein.

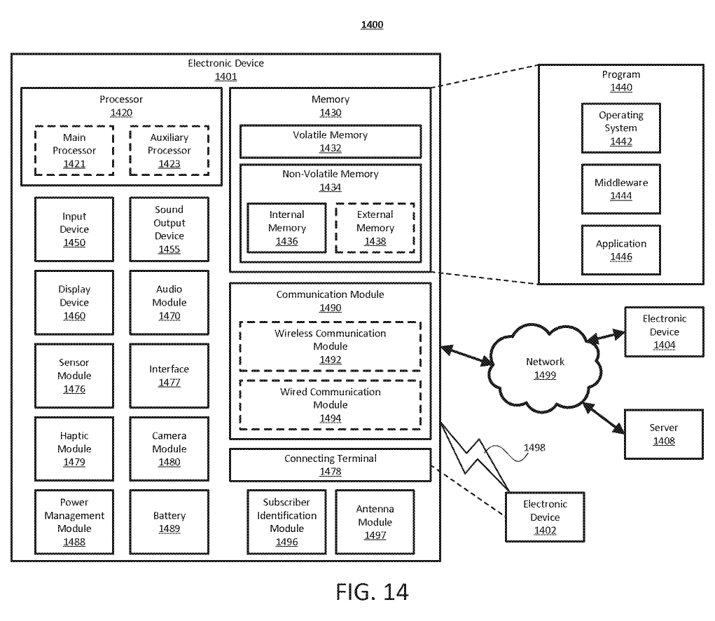

FIG. 14 is a block diagram of an electronic device in a network environment, according to embodiments of this disclosure.

Referring to FIG. 14, an electronic device 1401 in a network environment 1400 may communicate with an electronic device 1402 via a first network 1498 (e.g., a short-range wireless communication network), or an electronic device 1404 or a server 1408 via a second network 1499 (e.g., a long-range wireless communication network). The electronic device 1401 may communicate with the electronic device 1404 via the server 1408. The electronic device 1401 may include a processor 1420, a memory 1430, an input device 1450, a sound output device 1455, a display device 1460, an audio module 1470, a sensor module 1476, an interface 1477, a haptic module 1479, a camera module 1480, a power management module 1488, a battery 1489, a communication module 1490, a subscriber identification module (SIM) card 1496, or an antenna module 1497. In one embodiment, at least one (e.g., the display device 1460 or the camera module 1480) of the components may be omitted from the electronic device 1401, or one or more other components may be added to the electronic device 1401. Some of the components may be implemented as a single IC. For example, the sensor module 1476 (e.g., a fingerprint sensor, an iris sensor, or an illuminance sensor) may be embedded in the display device 1460 (e.g., a display).

The electronic device 1401 can represent a base station, such as a gNB, or a UE that performs sensing operations in an ISAC system. The processor 1420 can execute instructions to implement the sensing node switching methods described herein, including determining that a sensing quality metric is below a threshold, identifying a second node to perform a sensing operation based on a position and velocity of a mobile object, and transmitting a handover switch request to the second node. The communication module 1490 can transmit and receive sensing signals, as well as transmit handover switch requests. The memory 1430 can store sensing quality metric measurements, mobile object parameters such as position and velocity, Doppler frequency information, and micro-Doppler signatures.

The sensor module 1476 can include radar sensors, antenna arrays, or other sensing components that enable the electronic device 1401 to transmit sensing signals toward a mobile object and receive reflected sensing signals from the mobile object. The antenna module 1497 can include multiple antenna elements configured to perform beamforming operations, enabling the electronic device 1401 to direct sensing beams toward specific directions based on the position of a mobile object without requiring a full beam sweep.

The processor 1420 may execute software (e.g., a program 1440) to control at least one other component (e.g., a hardware or a software component) of the electronic device 1401 coupled with the processor 1420 and may perform various data processing or computations.

The processor 1420 can analyze the reflected sensing signals received via the sensor module 1476 and the antenna module 1497 to determine sensing quality metrics such as RSRP, RSRQ, location accuracy, velocity accuracy, or ratio of correct detection to missed and false detection.

When the electronic device 1401 operates as a first node initiating a sensing handover, the processor 1420 can compare the sensing quality metric against a threshold stored in memory 1430 or 1434. If the sensing quality metric falls below the threshold, the processor 1420 can identify a second node, which can be another base station or UE in the network environment 1400, and can cause the communication module 1490 to transmit a handover switch request comprising the position and velocity of the mobile object. When the electronic device 1401 operates as a second node receiving a handover switch request, the processor 1420 can extract the position and velocity information from the request, determine an appropriate sensing beam direction using the antenna module 1497, and perform sensing measurements on the mobile object. The processor 1420 can then determine whether its own sensing quality metric exceeds a threshold and can cause the communication module 1490 to transmit an ACK or NACK back to the first node.

As at least part of the data processing or computations, the processor 1420 may load a command or data received from another component (e.g., the sensor module 1476 or the communication module 1490) in volatile memory 1432, process the command or the data stored in the volatile memory 1432, and store resulting data in non-volatile memory 1434. The processor 1420 may include a main processor 1421 (e.g., a central processing unit (CPU) or an application processor (AP)), and an auxiliary processor 1423 (e.g., a graphics processing unit (GPU), an image signal processor (ISP), a sensor hub processor, or a communication processor) that is operable independently from, or in conjunction with, the main processor 1421. Additionally or alternatively, the auxiliary processor 1423 may be adapted to consume less power than the main processor 1421, or execute a particular function. The auxiliary processor 1423 may be implemented as being separate from, or a part of, the main processor 1421.

The auxiliary processor 1423 may control at least some of the functions or states related to at least one component (e.g., the display device 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). The auxiliary processor 1423 (e.g., an image signal processor or a communication processor) may be implemented as part of another component (e.g., the camera module 1480 or the communication module 1490) functionally related to the auxiliary processor 1423.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434. Non-volatile memory 1434 may include internal memory 1436 and/or external memory 1438.

The program 1440 may be stored in the memory 1430 as software, and may include, for example, an operating system (OS) 1442, middleware 1444, or an application 1446.

The input device 1450 may receive a command or data to be used by another component (e.g., the processor 1420) of the electronic device 1401, from the outside (e.g., a user) of the electronic device 1401. The input device 1450 may include, for example, a microphone, a mouse, or a keyboard.

The sound output device 1455 may output sound signals to the outside of the electronic device 1401. The sound output device 1455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1460 may visually provide information to the outside (e.g., a user) of the electronic device 1401. The display device 1460 may include, for example, a display, a hologram device, or a projector and control circuitry to control a corresponding one of the display, hologram device, and projector. The display device 1460 may include touch circuitry adapted to detect a touch, or sensor circuitry (e.g., a pressure sensor) adapted to measure the intensity of force incurred by the touch.

The audio module 1470 may convert a sound into an electrical signal and vice versa. The audio module 1470 may obtain the sound via the input device 1450 or output the sound via the sound output device 1455 or a headphone of an external electronic device 1402 directly (e.g., wired) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. The sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device 1402 directly (e.g., wired) or wirelessly. The interface 1477 may include, for example, a high- definition multimedia interface (HDMI), a universal serial bus (USB) interface, a secure digital (SD) card interface, or an audio interface.

A connecting terminal 1478 may include a connector via which the electronic device 1401 may be physically connected with the external electronic device 1402. The connecting terminal 1478 may include, for example, an HDMI connector, a USB connector, an SD card connector, or an audio connector (e.g., a headphone connector).

The haptic module 1479 may convert an electrical signal into a mechanical stimulus (e.g., a vibration or a movement) or an electrical stimulus which may be recognized by a user via tactile sensation or kinesthetic sensation. The haptic module 1479 may include, for example, a motor, a piezoelectric element, or an electrical stimulator.

The camera module 1480 may capture a still image or moving images. The camera module 1480 may include one or more lenses, image sensors, image signal processors, or flashes. The power management module 1488 may manage power supplied to the electronic device 1401. The power management module 1488 may be implemented as at least part of, for example, a power management integrated circuit (PMIC).

The battery 1489 may supply power to at least one component of the electronic device 1401. The battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the AP) and supports a direct (e.g., wired) communication or a wireless communication. The communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as BLUETOOTH^{TM}, wireless-fidelity (Wi-Fi) direct, or a standard of the Infrared Data Association (IrDA)) or the second network 1499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The antenna module 1497 may transmit or receive a signal or power to or from the outside (e.g., the external electronic device) of the electronic device 1401. The antenna module 1497 may include one or more antennas, and, therefrom, at least one antenna appropriate for a communication scheme used in the communication network, such as the first network 1498 or the second network 1499, may be selected, for example, by the communication module 1490 (e.g., the wireless communication module 1492). The signal or the power may then be transmitted or received between the communication module 1490 and the external electronic device via the selected at least one antenna.

Commands or data may be transmitted or received between the electronic device 1401 and the external electronic device 1404 via the server 1408 coupled with the second network 1499. Each of the electronic devices 1402 and 1404 may be a device of a same type as, or a different type, from the electronic device 1401. All or some of operations to be executed at the electronic device 1401 may be executed at one or more of the external electronic devices 1402, 1404, or 1408. For example, if the electronic device 1401 is to perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1401. The electronic device 1401 may provide the outcome, with or without further processing of the outcome, as at least part of a reply to the request. To that end, a cloud computing, distributed computing, or client-server computing technology may be used, for example.

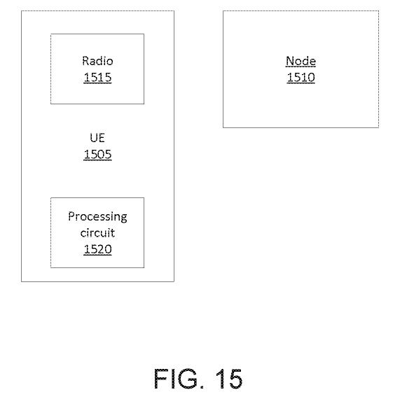

FIG. 15 shows a system including a UE 1505 and a gNB 1510, in communication with each other, according to embodiments of this disclosure.

Referring to FIG. 15, the UE may include a radio 1515 and a processing circuit (or a means for processing) 1520, which may perform various methods disclosed herein, e.g., the method illustrated in FIG. 13. For example, the processing circuit 1520 may receive, via the radio 1515, transmissions from the network node (gNB) 1510, and the processing circuit 1520 may transmit, via the radio 1515, signals to the gNB 1510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for sensing node or mode switching in an integrated sensing and communication (ISAC) system, the method comprising:
identifying, by a first node, a second node to perform a sensing operation based on a position or velocity of a mobile object; and
transmitting, from the first node, a switch request to the second node, wherein the switch request comprises the position or velocity of the mobile object.

2. The method of claim 1, wherein the sensing operation comprises at least one of mono-static sensing node switching, bi-static sensing node switching, multi-static sensing node switching, mode switching between mono-static sensing and bi-static sensing, or mode switching between bi-static sensing and multi-static sensing.

3. The method of claim 1, further comprising:
determining, by the first node, that a sensing quality metric is less than a threshold,
wherein the sensing quality metric comprises at least one of a sensing reference signal received power (RSRP), a sensing reference signal received quality (RSRQ), a sensing latency, a location accuracy, a velocity accuracy, or a ratio of correct detection to missed and false detection.

4. The method of claim 1, wherein the switch request is carried by at least one of a radio resource control (RRC) message, a medium access control-control element (MAC-CE), downlink control information (DCI), or uplink control information (UCI).

5. The method of claim 1, wherein the first node comprises a base station and the second node comprises a user equipment (UE).

6. The method of claim 1, wherein the first node comprises a user equipment (UE) and the second node comprises a base station.

7. The method of claim 1, wherein the first node comprises a first base station and the second node comprises a second base station.

8. The method of claim 1, further comprising:
transmitting the switch request to a plurality of candidate nodes; and
selecting one of the plurality of candidate nodes based on a request acknowledgement (ACK) received from at least one of the plurality of candidate nodes.

9. The method of claim 1, wherein the mobile object comprises an unmanned aerial vehicle (UAV).

10. The method of claim 1, wherein the switch request further comprises at least one of an object identifier, a Doppler frequency, a micro-Doppler signature, a sensing mode, or a sensing signal configuration associated with the mobile object.

11. A system including a first node for sensing node or mode switching in an integrated sensing and communication (ISAC) system, the first node comprising:
a processor; and
a memory storing program instructions that, when executed by the processor, configure the first node to:
identify a second node to perform a sensing operation based on a position or velocity of a mobile object; and
transmit a switch request to the second node, wherein the switch request comprises the position or velocity of the mobile object.

12. The system of claim 11, wherein the sensing operation comprises at least one of mono-static sensing node switching, bi-static sensing node switching, multi-static sensing node switching, mode switching between mono-static sensing and bi-static sensing, or mode switching between bi-static sensing and multi-static sensing.

13. The system of claim 11, wherein the program instructions further configure the first node to determine that a sensing quality metric is less than a threshold, and
wherein the sensing quality metric comprises at least one of a sensing reference signal received power (RSRP), a sensing reference signal received quality (RSRQ), a sensing latency, a location accuracy, a velocity accuracy, or a ratio of correct detection to missed and false detection.

14. The system of claim 11, wherein the switch request is carried by at least one of a radio resource control (RRC) message, a medium access control-control element (MAC-CE), downlink control information (DCI), or uplink control information (UCI).

15. The system of claim 11, wherein the first node comprises a base station and the second node comprises a user equipment (UE).

16. The system of claim 11, wherein the first node comprises a user equipment (UE) and the second node comprises a base station.

17. The system of claim 11, wherein the first node comprises a first base station and the second node comprises a second base station.

18. The system of claim 11, wherein the program instructions further configure the first node to:
transmit the switch request to a plurality of candidate nodes; and
select one of the plurality of candidate nodes based on a switch request acknowledgement (ACK) received from at least one of the plurality of candidate nodes.

19. The system of claim 11, wherein the mobile object comprises an unmanned aerial vehicle (UAV).

20. The system of claim 11, wherein the switch request further comprises at least one of an object identifier, a Doppler frequency, a micro-Doppler signature, a sensing mode, or a sensing signal configuration associated with the mobile object.
